(19) United States
(12) Patent Application Publication
(10) Pub. No.: US 2007/0211014 A1
(43) Pub. Date: Sep. 13, 2007

(54) Methods and Circuits for Synchronous Operation of Display Backlighting

(76) Inventors: Hyoung-Rae Kim, Gyeonggi-do (KR); Dong-Yul Lee, Seoul (KR)

Correspondence Address: MYERS BIGEL SIBLEY & SAJOVEC, PO BOX 37428, RALEIGH, NC, 27627, US

(21) Appl. No.: 11/684,335

(22) Filed: Mar. 9, 2007

(30) Foreign Application Priority Data
Mar. 10, 2006 (KR) 10-2006-0022797

(51) Int. Cl. G09G 3/36

(52) U.S. Cl. 345/102

(57) ABSTRACT

A method of controlling backlighting of a Liquid Crystal Display (LCD) can include generating an on-time signal to activate a backlight for an LCD in synchronization with providing a frame of data to the LCD.

### CROSS-REFERENCE TO RELATED APPLICATION

The present application claims priority to Korean Patent Application No. 10-2006-0022797, filed in the Korean Intellectual Property Office on Mar. 10, 2006, the disclosure of which is incorporated herein by reference.

### FIELD OF THE INVENTION

The present invention relates generally to the field of electronics and, more particularly, to methods and circuits for driving electronic displays.

### BACKGROUND

It is known to provide lighting for displays, such as Liquid Crystal Displays (LCD), by a configuration commonly referred to as “backlighting.” In some applications, backlighting can be provided using light emitting devices which emit light through the LCD to provide for illumination, particularly in applications where the LCD is used in a mobile device such as a laptop computer.

Because of the sensitivity to battery life in such portable devices, power consumption associated with backlighting has been the subject of investigation. In particular, it is known to switch the backlighting on/off in an attempt to reduce power that would otherwise be consumed by the LCD backlighting. It is also known to reduce the intensity of the backlighting in an attempt to further reduce power consumption of such portable devices. For example, it is known that under idealized conditions, an observer may not be able to distinguish between a rather high intensity light provided for a somewhat short time interval at a fixed frequency and backlighting provided at a lower intensity for a longer time interval at the same fixed frequency. Accordingly, it is known to switch the backlighting on/off at a reduced intensity for a longer time intervals in an effort to further reduce power consumption in backlighting of LCDs.

One approach to providing backlighting control is shown in FIGS. 1A and 1B, where a Pulse Width Modulation (PWM) signal is provided to a bank of switches coupled to corresponding LEDs which are switched on when the PWM signal is activated so that the LEDs provide backlighting for the LCD. Furthermore, when the PWM signal is disabled (i.e., the t_{off} shown in FIG. 1B), the bank of switches are disengaged from the LEDs, thereby terminating the backlight.

The above approach can lead to undesirable imaging artifacts. In particular, the human eye may be particularly sensitive to interactions between the frequency at which the LCD is updated with data and the frequency at which the backlighting is provided. This phenomenon is commonly referred to as “flicker,” which can be caused by an interference pattern between the two different frequencies that is manifested as variations in brightness of the display. Furthermore, the human eye can be particularly sensitive to flicker at relatively low levels of luminance where the relationship between luminance and brightness has an extremely nonlinear relationship.

One approach used to address the above flicker artifact is to increase the frequency at which the backlighting is switched on/off so that any interference which may otherwise generate substantial amounts of flicker may be reduced as the overall level of brightness is increased due to the additional backlight on-time during a frame. Unfortunately, this approach can lead to relatively high levels of power consumption by the backlighting.

Different approaches to backlighting of LCDs are discussed in, for example, in Japanese Patent Application JP 11-003039 entitled “LCD Backlight On/Off Circuit,” U.S. Patent Application Publication Number US 2003/0178951 by Park et al., U.S. Patent Application Publication Number US 2005/0242756 by Honbo, U.S. Patent Application Publication Number US 2005/0062681 by Honbo, and U.S. Patent Application Publication Number US 2006/0139289 by Yoshida et al.

### SUMMARY

Embodiments according to the invention can provide methods and circuits for synchronous operation of display backlighting. Pursuant to these embodiments, a method of controlling backlighting of a Liquid Crystal Display (LCD) can include generating an on-time signal to activate a backlight for an LCD in synchronization with providing a frame of data to the LCD.

In some embodiments according to the invention, a method of controlling backlighting of an LCD cam include generating an on-time signal having a variable duty cycle within and synchronous to a frame time in which a frame of data is provided to an LCD and a having a substantially constant frequency over a plurality of frame times.

In some embodiments according to the invention, a method of controlling backlighting of an LCD panel can include generating a pulse width modulation signal to control a backlight for an LCD panel in synchronization with providing a frame of data to the LCD panel and in synchronization with providing a line of data within the frame of data to the LCD panel.

In some embodiments according to the invention, a method of controlling backlighting of an LCD can include generating an on-time signal in synchronization with providing a line of data within a frame of data to an LCD. In some embodiments according to the invention, a method of controlling backlighting of an LCD can include generating an on-time signal in synchronization with a clock from an LCD driver IC to avoid activation of the on-time signal spanning adjacent frames of data to an LCD.

In some embodiments according to the invention, an interface to an LCD panel can include a plurality of signals transmitted from a processor circuit, the plurality of signals being free of a dedicated pulse width modulation control signal configured to control on-time for a backlight of an LCD panel. In some embodiments according to the invention, a circuit can include an LCD driver integrated circuit configured to provide data to an LCD panel synchronous to a clock signal and to provide an on-time signal synchronous with the clock signal.

### BRIEF DESCRIPTION OF THE DRAWINGS

FIG. 1A is a schematic illustration of a conventional backlight control circuit.

FIG. 1B is a timing diagram illustrating operation of the conventional backlight control circuit shown in FIG. 1A.

FIG. 2 is a block diagram illustrating methods and circuits for synchronous operation of backlighting according to some embodiments of the invention.

FIG. 3 is a block diagram that illustrates an LCD driver IC providing an on-time signal to a display driver IC according to some embodiments of the invention.

FIG. 4 is a timing diagram that illustrates operations of the LCD driver integrated circuits shown in FIG. 3 according to some embodiments of the invention.

FIG. 5 is a schematic representation of the generation of on-time signals for backlighting synchronous with the start of a frame of data provided to an LCD panel in some embodiments according to the invention.

FIG. 6 is a block diagram that illustrates circuits and methods of LCD driver integrated circuits providing on-time signals to a backlighting circuit according to some embodiments of the invention.

FIG. 7 is a timing diagram that illustrates operations of LCD driver integrated circuits shown in FIG. 6 according to some embodiments of the invention.

FIGS. 8A and 8B are schematic representations of the operation of a conventional backlighting circuit and a backlighting circuit according to some embodiments of the invention, respectively.

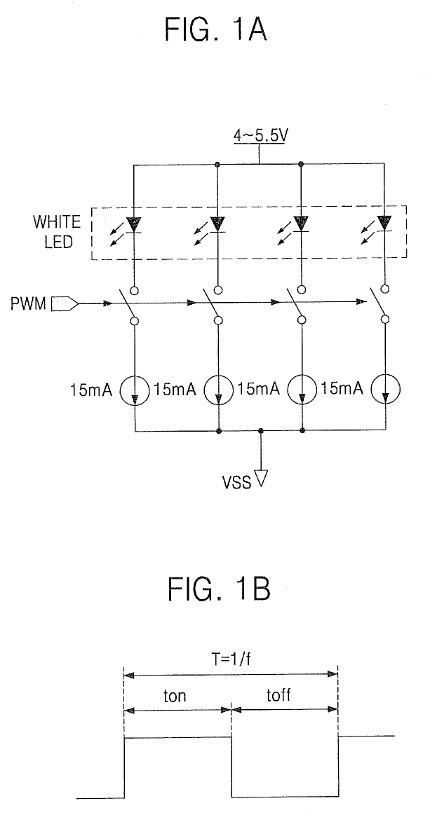

### DESCRIPTION OF THE EMBODIMENTS ACCORDING TO THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As described hereinbelow in greater detail, an on-time signal used to control activation of a backlight for an LCD panel can be generated synchronous with a frame of data provided to the LCD panel. For example, in some embodiments according to the invention, the on-time signal is generated synchronous with a signal used to provide a line of data within a frame of data. In other embodiments according to the invention, the on-time signal is activated synchronous with the activation of a start-of-frame signal provided to the LCD panel and deactivated synchronous with the activation of a start-of-line signal provided to the LCD panel during the frame or, alternatively, synchronous with activation of a subsequent start-of-frame signal.

It will be understood that in some embodiments according to the invention, activation of the on-time signal is synchronous with a start-of-line signal where the on-time signal transitions from a low to high level in response to the transition of a start-of-frame signal from a low level to a high level.

In still other embodiments according to the invention, a timing controller circuit receives a command to deactivate the on-time signal synchronous with a particular transition of a start-of-line signal within the frame of data to adjust the amount of light provided by the backlight to the LCD panel. In still further embodiments according to the invention, the activation of the on-time signal is adjusted to have a variable duty cycle within and synchronous to a frame during which data is provided to the LCD panel and, moreover, to have a substantially constant frequency over a plurality of frame times. In other words, in some embodiments according to the invention, the duty cycle of the on-time signal can be adjusted to provide different levels of backlighting to the display while still maintaining a substantially constant frequency over a number of frame times.

In still other embodiments according to the invention, the on-time signal is generated in synchronization with a clock from an LCD driver IC to help avoid activation of the on-time signal spanning adjacent frames of data. Accordingly, the synchronization of the on-time signal can promote a constant level of lighting to each of the frames and avoid an asynchronous situation where, for example, a single on-time signal could activate the backlight, at least partially, during two time adjacent frames.

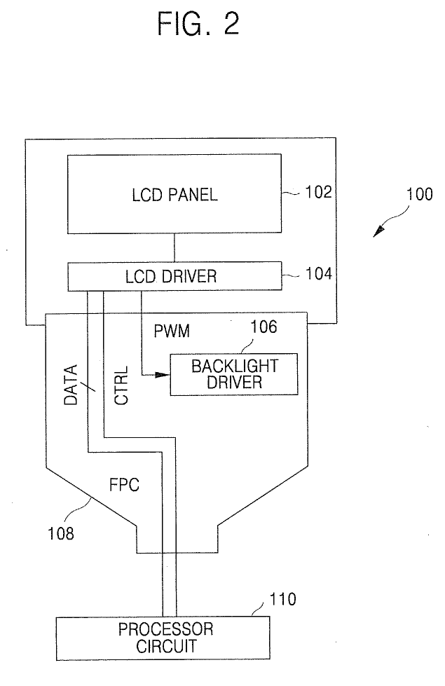

FIG. 2 is a block diagram that illustrates an LCD panel having data provided thereto by an LCD driver IC in synchronization with backlighting provided thereto by a backlight driver IC in some embodiments according to the invention. As shown in FIG. 2, a processor circuit 110 provides a plurality of control/data signals to an LCD driver IC 104 included in a display system 100. The plurality of data/control signals can be used to provide, for example, data that is ultimately driven to an LCD panel 102 as well as general timing parameters for the operation of the LCD system 100, such as horizontal sync, vertical sync, etc. In some embodiments according to the invention, the processor circuit 110 can be an application processor or a base band processor such as that used to coordinate operations of a mobile telephone, laptop computer, or other mobile device.

As further shown in FIG. 2, the LCD driver IC 104 provides an on-time signal PWM to a backlight driver IC 106. In some embodiments according to the invention, the on-time signal PWM is generated by the backlight driver IC 104 in synchronization with the data that is provided to the LCD panel 102. It will be further understood that the plurality of data/control signals provided by the processor circuit 110 to the driver IC 104 can be free of a dedicated on-time signal used to control backlighting of the LCD panel 102 as this control can be provided by the LCD driver IC 104 providing the on-time signal to the backlight driver IC 106. In some embodiments according to the invention, the data provided by the LCD driver IC 104 to the LCD panel 102 includes data to be displayed thereon and timing signals, such as a start-of-frame signal, which can indicate the start of a frame of data being provided to the LCD panel 102. Accordingly, the on-time signal provided by the LCD driver IC 104 to the backlight driver IC 106 can be generated in synchronization with the start-of-frame signal provided to the LCD display 102.

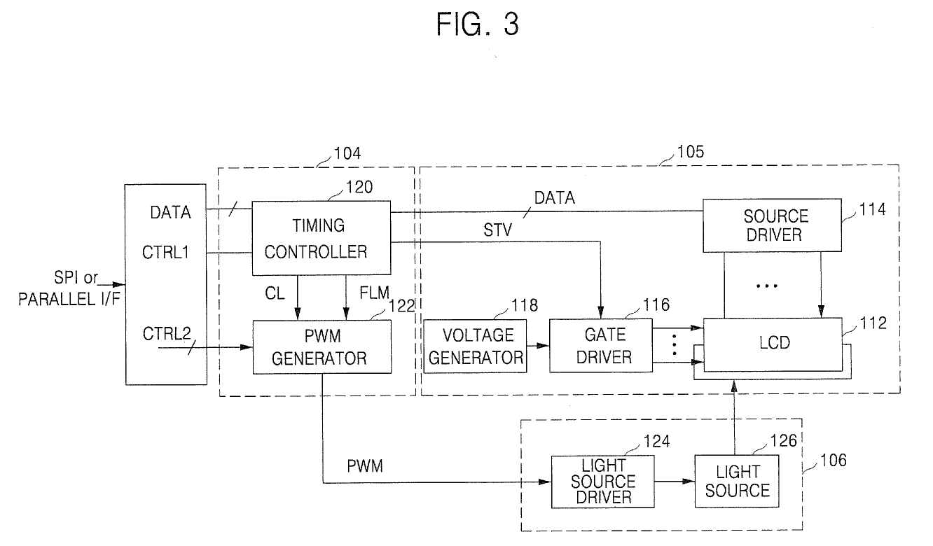

FIG. 3 is a block diagram that illustrates an IC (i.e., circuit) used to provide data for the LCD panel 102 as well as timing control signals for the display of that data thereon. The LCD driver IC 104 is also configured to provide the on-time signal to the backlight driver IC 106 in synchronization with a start-of-frame control signal.

As further shown in FIG. 3, data/control signals can be provided by the processor circuit 110 to the LCD driver circuit 104 over a Serial Peripheral Interface (SPI), parallel interface, or other type of interface that can be used by the processor circuit to control the display system 100. In particular, control signal CTRL1 can indicate to the LCD driver circuit 104 the general timing parameters for operation of the start-of-frame signal and control signal CTRL2 can indicate a duty cycle to be assigned to the on-time signal provided to the backlight driver IC 106.

In greater detail, the LCD driver circuit 104 includes a timing controller circuit 120 that receives the data and control signal CTRL1 to generate a start-of-frame signal STV for a gate driver circuit 116 that controls the activation of a panel 105 based on biasing provided by a voltage generator 118. The timing controller circuit 120 also provides the data to a source driver 114 that drives the LCD 112 to provide an image thereon. It will be understood that the source driver 114, the gate driver circuit 116, and the voltage generator 118 may be included in the display panel 102, separate from the LCD driver IC 104, although in some other embodiments according to the invention, some of these components (or functions) may be included in systems or devices outside the panel 102.

The timing controller circuit 120 also provides a clock signal CL and a timing signal FLM that indicates, to a pulse width modulation generator circuit 122, a start of a single frame of data being provided to the display panel 102. The pulse width modulation generator circuit 122 generates an on-time signal in synchronization with the timing signal FLM that indicates the start of the frame of data. In particular, in some embodiments according to the invention, the pulse width modulation generator circuit 122 can activate the on-time signal to the backlight driver IC 106 in response to an activating edge of the FLM signal and deactivate the on-time signal responsive to a particular edge of the clock signal CL within the frame of data, where the clock signal CL indicates the timing for a particular line of data within the frame. According to FIG. 3, the on-time signal is provided to a light source driver 124 in the backlight driver IC 106, which activates a light source 126 to backlight the LCD 112.

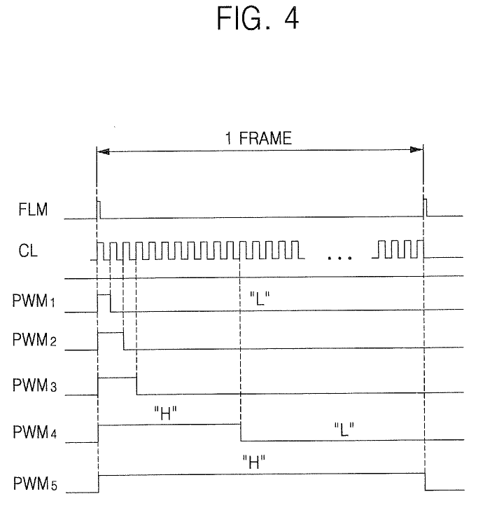

FIG. 4 is a timing diagram that illustrates operations of an LCD driver IC 104 shown in FIG. 3. In particular, the FLM indicates the start of a frame of data provided to the display panel 102 by the timing controller circuit 120. Accordingly, the period of the FLM corresponds to the timing for a single frame of data to be displayed on the display panel 102. As shown in FIG. 4, any of the on-time signals PWM₁₋₅ is provided synchronous thereto so that the activation of the on-time signal PWM is responsive to activation of the FLM. For example, any of the on-time signals PWM₁₋₅ can transition from low to high responsive to a low to high transition of the FLM.

Furthermore, deactivation of the on-time signals PWM₁₋₅ is synchronous with activation of a line of data being provided to the display panel 102, which can be adjusted to provide a desired amount of light to illuminate the LCD 112. For example, on-time signal PWM₁ is activated responsive to the rising edge of FLM and deactivated responsive to the rising edge of the second cycle of clock signal CL (i.e., the start of the second line of data being provided to the display panel 102.

In comparison, the on-time signal PWM₂ is shown being deactivated responsive to the activation of the clock signal CL indicating the start of a third line of data being provided to the display panel 102. On-time signal PWM₃ is deactivated responsive to the fourth line of data being provided to the display panel 102. Similarly, the on-time signal PWM₄ is shown being deactivated responsive to start of the fifth line of data being provided to the display panel 102. Finally, the on-time signal PWM₅ is shown being deactivated responsive to the start of the next subsequent low to high transition of the FLM indicating the start of the next frame of data provided to the display panel 102.

As shown in FIG. 4, activation of the backlighting provided to illuminate the LCD 112 can be adjusted synchronous to providing a frame of data to the display panel 112 so as to reduce the likelihood that illumination of the display may span two time adjacent frames of data which may, if unaddressed, manifest itself as flicker in the display.

In some embodiments according to the invention, the backlighting of the display panel 112 can be controlled from about 0.0 nits (Candela per square meter) to about a maximum desired luminance. For example, in some embodiments according to the invention, the backlighting of the display panel 112 can be controlled from about 0.0 nits to about 300 nits. In some embodiments according to the invention, the backlighting of the display panel 112 can be controlled from about 0.0 nits to about 400 nits.

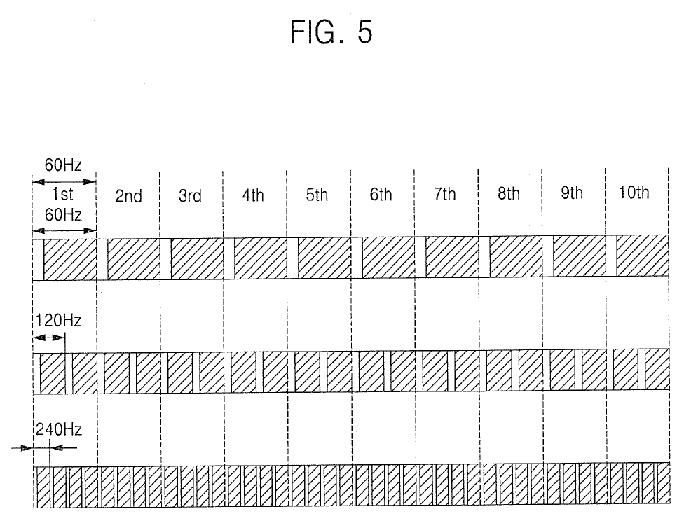

FIG. 5 is a schematic illustration of different backlighting schemes wherein an on-time signal is provided synchronous with providing data to the display. As shown in FIG. 5, the backlight can be operated at a frequency of about 60 Hz in a display wherein data is also provided to the display at a rate of about 60 Hz. In some embodiments according to the invention, illumination by the backlight is limited to a single on-time within each of the frames of data (i.e., first through tenth frames). Moreover, the amount of backlighting provided in each of the frames is substantially equal so that perceptible flicker can be reduced.

As further shown in FIG. 5, in some embodiments according to the invention, the frequency of the backlighting can be increased to 120 Hz so that the backlight is activated twice within a single frame of data. Moreover, as shown in FIG. 5, the amount of backlighting provided in each of the frames is equal and, furthermore, the amount of backlighting provided at 120 Hz is substantially equal to the amount of light provided at 60 Hz.

As further shown in FIG. 5, in some embodiments according to the invention, the frequency of the backlighting can be provided at 240 Hz so that the backlight is activated approximately four times within a single frame of data. According to FIG. 5, the amount of lighting provided to each of the frames is substantially equal. Moreover, the amount of lighting provided to a single frame of data at 240 Hz is substantially equal to the amount of lighting provided to a single frame at 120 Hz, and substantially equal to the amount of lighting provided to a single frame at 60 Hz. Accordingly, the frequency of the on-time signal can be selected so that the backlighting is synchronously switched on/off multiple times during each of the frame times to provide substantially constant illumination of the display to reduce perceptible flicker in situations where the brightness of the display is particularly low, or provided with data including relatively high rates of motion where, in conventional schemes, flicker may be more apparent.

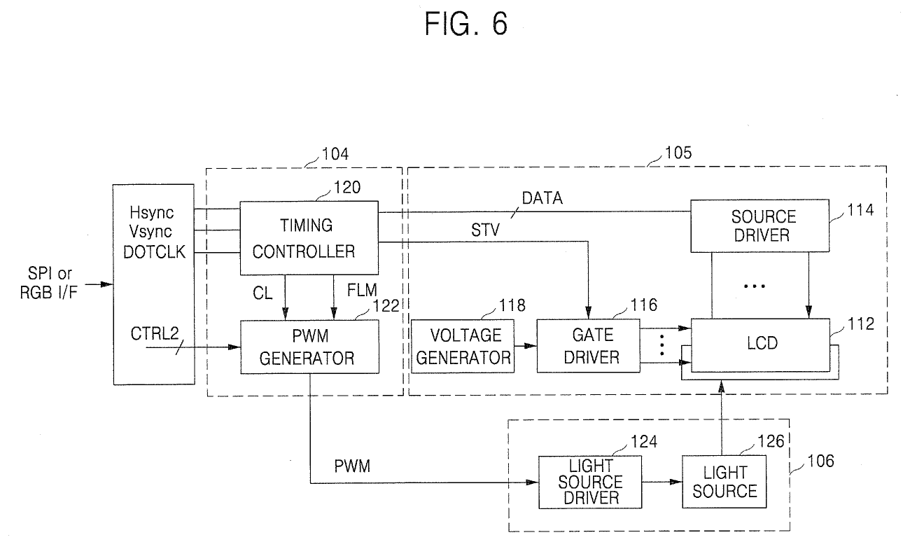

FIG. 6 is a block diagram that illustrates an LCD driver IC 104 according to some embodiments of the invention. In particular, as shown in FIG. 6, the interface provided to the display driver IC 104 is in compliance with an RGB format wherein Hsync, Vsync, and a dot clock are provided to the LCD driver IC 104. According to FIG. 6, the timing controller circuit 120 uses the Hsync, Vsync, and the dot clock signals (i.e., the control signals) to generate a start-of-frame signal STV provided to the gate driver circuit 116 for activation of a frame of data to be displayed on the display panel 112. The timing controller circuit 120 also generates a clock signal CL and FLM responsive to the Vsync signal and a clock signal indicating the start of each of the lines of data to be display on the LCD 112.

The PWM generator circuit 122 uses the clock signal CL and FLM signal to provide the on-time signal synchronous with providing the data to the display panel 102. In particular, the PWM generator circuit 122 activates the on-time signals PWM₁₋₅ responsive to activation of the FLM and can deactivate the on-time signals PWM₁₋₅ responsive to any of the clock signals CL (indicating the start of a particular line of data provided to the display panel 102) or alternatively, responsive to activation of the next FLM.

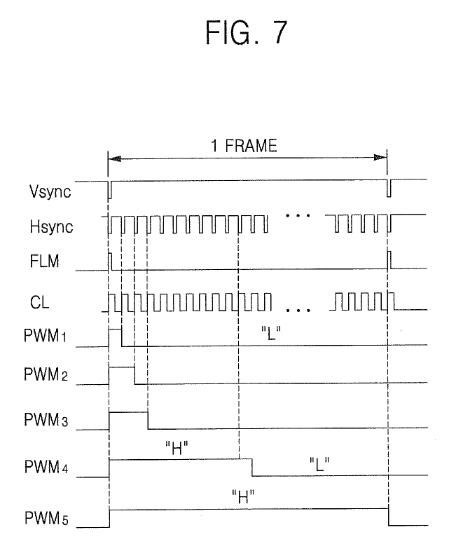

FIG. 7 is a timing diagram that illustrates operations of the circuit 104 shown in FIG. 6 according to some embodiments of the invention. As shown in FIG. 7, the frame time can be provided by the Vsync signal, whereas the time for a particular line of data can be indicated by the Hsync signal. The FLM can be based on the received Vsync signal and the clock signal CL indicating the start of a particular line of data to the display 112 can be based on the Hsync signal.

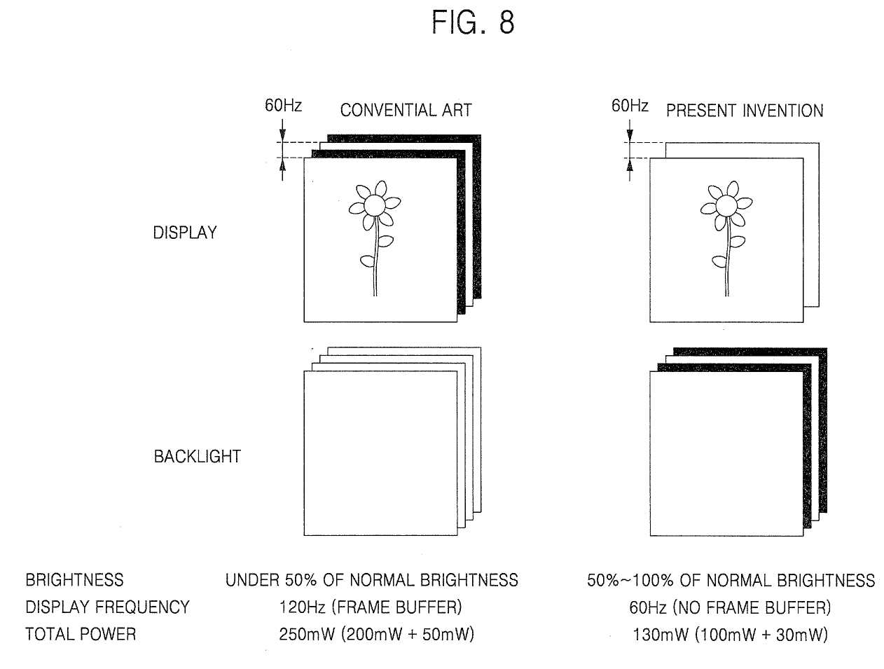

FIGS. 8A and 8B are schematic illustrations of backlighting of an LCD according to a conventional approach and in some of the embodiments according to the invention, respectively. According to FIG. 8A, a conventional display including a frame buffer illuminates the display in each of four adjacent frame times provided at 60 Hz. As further shown in FIG. 8A, the frame buffer only provides an image for display every other frame whereas the frame buffer includes black data in every intervening frame. However, the backlight is switched on for each of these frames including the frames where only black data is provided. Accordingly, the brightness of a display operated according to this approach can be about half the normal brightness and consume a power of about 250 milliwatts.

In contrast, FIG. 8B shows the backlighting turned off when data is not to be displayed. Accordingly, such a display may provide a brightness of more than 50% of normal brightness at a power of about 130 milliwatts.

As described above an on-time signal used to control activation of a backlight for an LCD panel can be generated synchronous with a frame of data provided to the LCD panel. For example, in some embodiments according to the invention, the on-time signal is generated synchronous with a signal used to provide a line of data within a frame of data. In other embodiments according to the invention, the on-time signal is activated synchronous with the activation of a start-of-frame signal provided to the LCD panel and deactivated synchronous with the activation of a start-of-line signal provided to the LCD panel during the frame or, alternatively, synchronous with activation of a subsequent start-of-frame signal.

It will be understood that in some embodiments according to the invention, activation of the on-time signal is synchronous with a start-of-line signal where the on-time signal transitions from a low to high level in response to the transition of a start-of-frame signal from a low level to a high level.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed:

1. A method of controlling backlighting of a Liquid Crystal Display (LCD) comprising:
generating an on-time signal to activate a backlight for an LCD in synchronization with providing a frame of data to the LCD.

2. A method according to claim 1 further comprising:
generating the on-time signal in synchronization with providing a line of data within the frame of data to the LCD.

3. A method according to claim 2 wherein generating the on-time signal in synchronization with providing a line of data within the frame of data to the LCD comprises:
activating the on-time signal synchronous with activation of a start of frame signal; and
de-activating the on-time signal synchronous with activation of a start of line signal within the frame of data or synchronous with activation of a subsequent start of frame signal.

4. A method according to claim 3 wherein activating the on-time signal comprises activating the on-time signal responsive to activation of the start of frame signal; and
wherein de-activating the on-time signal comprises de-activating the on-time signal responsive to activation of the start of line signal within the frame of data or responsive to activation of the subsequent start of frame signal.

5. A method according to claim 3 wherein de-activating the on-time signal further comprises:
selecting one of a plurality of start of line signals occurring subsequent to the start of frame signal on which the on-time signal is to be de-activated synchronous with the selected start of line signal to adjust backlighting of the LCD.

6. A method according to claim 5 further comprising:
receiving a command to de-activate the on-time signal to increase or decrease an amount of light provided to the LCD.

7. A method according to claim 1 wherein generating the on-time signal comprises:
receiving a first signal indicating a start of the frame;
receiving a second signal indicating a time associated with a line of data; and
providing a Pulse Width Modulation (PWM) signal responsive to the first and second signals.

8. A method according to claim 2 wherein the first and second signals comprise a Vsync signal and an Hsync signal.

9. A method according to claim 1 further comprising:
modifying a duration of the on-time signal to modify a perceived brightness of the LCD.

10. A method according to claim 9 wherein modifying a duration comprises modifying the duration of the on-time signal responsive to a command from a processor.

11. A method according to claim 10 wherein the command is provided via an Serial Peripheral Interface (SPI).

12. A method according to claim 7 wherein the pulse width modulation signal has frequency that is a multiple of a frequency of a start of frame signal.

13. A method of controlling backlighting of a Liquid Crystal Display (LCD) comprising:
generating an on-time signal having a variable duty cycle within and synchronous to a frame time in which a frame of data is provided to an LCD and a having a substantially constant frequency over a plurality of frame times.

14. A method of controlling backlighting of a Liquid Crystal Display (LCD) comprising:
generating a pulse width modulation signal to control a backlight for an LCD panel in synchronization with providing a frame of data to the LCD panel and in synchronization with providing a line of data within the frame of data to the LCD panel.

15. A method of controlling backlighting of a Liquid Crystal Display (LCD) comprising:
generating an on-time signal in synchronization with providing a line of data within a frame of data to an LCD.

16. A method of controlling backlighting of a Liquid Crystal Display (LCD) comprising:
generating an on-time signal in synchronization with a clock from an LCD driver IC to avoid activation of the on-time signal spanning adjacent frames of data to an LCD.

17. An interface to a Liquid Crystal Display (LCD) panel comprising:
a plurality of signals transmitted from a processor circuit, the plurality of signals being free of a dedicated pulse width modulation control signal configured to control on-time for a backlight of an LCD panel.

18. A circuit comprising:
a Liquid Crystal Display (LCD) driver integrated circuit configured to provide data to an LCD panel synchronous to a clock signal and to provide an on-time signal synchronous with the clock signal.

19. A circuit according to claim 18 further comprising:
a pulse width modulation signal generator circuit configured to modify an active time of the on-time signal synchronous with the clock signal.

20. A circuit according to claim 18 further comprising:
a timing controller circuit configured to interface to an application or baseband processor over an Serial Peripheral Interface (SPI) or Red-Green-Blue (RGB) interface and configured to provide a line clock signal indicating a start time of a line of data for the LCD panel and to provide a start of frame signal indicating a start time for a frame of data for the LCD panel.

21. A circuit according to claim 20 wherein the timing controller circuit is configured to interface over the RGB interface, wherein the circuit is free of a frame buffer configured to store data for display on the LCD panel.

22. A circuit according to claim 18 wherein the clock signal is generated by the LCD driver integrated circuit.

23. A circuit according to claim 18 further comprising:
a LED driver circuit configured to receive the pulse width modulation signal from the LCD driver integrated circuit.

24. A circuit according to claim 20 wherein the timing controller circuit is configured to interface over the SPI to receive a command from the processor to control a duty cycle of the on-time signal.

25. A circuit according to claim 19 wherein the pulse width modulation signal generator circuit is configured to activate the on-time signal synchronous with activation of the start of frame signal and configured to de-activate the on-time signal synchronous with activation of a start of line signal within the frame of data or synchronous with activation of a subsequent start of frame signal.

26. A circuit according to claim 25 wherein the pulse width modulation signal generator circuit is further configured to activate the on-time signal responsive to activation of the start of frame signal and configured to de-activate the on-time signal responsive to activation of the start of line signal within the frame of data or responsive to activation of the subsequent start of frame signal.

27. A circuit according to claim 20 wherein the processor is configured to select a time associated with one of a plurality of start of line signals occurring subsequent to the start of frame signal on which the on-time signal is to be de-activated synchronous with the selected start of line signal; and
wherein the pulse width modulation signal generator circuit is further configured to de-activate the on-time signal responsive to the selected start of line signal to adjust backlighting of the LCD.

28. A circuit according to claim 27 further comprising:
receiving a command to de-activate the on-time signal to increase or decrease an amount of light provided to the LCD.

29. A circuit according to claim 18 included in a mobile telephone, a television, a personal data assistant, or a computer display.
